(19) United States
(12) Patent Application Publication
(10) Pub. No.: US 2014/0168776 A1
(43) Pub. Date: Jun. 19, 2014

(54) ANTIREFLECTION FILM AND ANTIREFLECTION PLATE

(71) Applicants: Masahiro Saito, Fukui (JP); Hirokazu Hashimoto, Fukui (JP); Yukari Ikeda, Fukui (JP)

(72) Inventors: Masahiro Saito, Fukui (JP); Hirokazu Hashimoto, Fukui (JP); Yukari Ikeda, Fukui (JP)

(73) Assignee: FUKUVI CHEMICAL INDUSTRY CO., LTD., Fukui (JP)

(21) Appl. No.: 14/235,619

(22) PCT Filed: Aug. 1, 2011
(86) PCT No.: PCT/JP2011/067617

§ 371 Date: Jan. 28, 2014

(51) Int. Cl. G02B 1/10; G02B 1/04; G02B 1/11

(52) U.S. Cl. CPC G02B 1/105; G02B 1/115; G02B 1/04
USPC 359/586

(57) ABSTRACT

An antireflection film has excellent scratch resistance and damp-proof property in addition to having a high degree of antireflective effect, and provides an antireflection plate obtained by laminating the above film. The antireflection film has a lowly refractive layer of a refractive index of less than 1.48 and a thickness of 50 to 200 nm. An antireflection plate includes the antireflection film formed on a transparent resin substrate.

### TECHNICAL FIELD

This invention relates to an antireflection film having a high degree of antireflective effect, excellent scratch resistance and damp-proof property, and to an antireflection plate obtained by laminating the antireflection film thereon.

### BACKGROUND ART

Antireflection films have heretofore been widely used for the front panels of optical display devices such as CRTs, LCDs and plasma display devices. As means for forming the antireflection films, there have generally been employed a vacuum evaporation method, a sputtering method as well as a wet-coating method.

There have, further, been widely known antireflection plates obtained by forming a multiplicity of films on a plastic substrate, such as an antireflection plate having excellent wear resistance, scratch resistance, adhesiveness and light transmitting property, and comprising, for example, a plastic substrate having light transmitting property, a highly refractive layer having an antistatic property and containing chiefly a metal alkoxide and a colloidal metal oxide and/or a metal halide and being applied onto the substrate, an antireflection layer of an amorphous fluorine-contained resin having a refractive index (nd) of not more than 1.36 and being applied onto the highly refractive layer, and a layer containing chiefly an organic polysiloxane and a fluorine type material having surface activating capability and being applied onto the antireflection film (patent document 1).

The present inventors, too, have proposed an antireflection film having a non-glaring function comprising three layers using hollow silica sol that has voids therein, and an antireflection film featuring excellent durability and oil-proof property having a layer that contains a silane compound and a metal chelate compound in combination (patent document 3).

### PRIOR ART DOCUMENTS

### Patent Documents

Patent document 1: JP-A-9-288202
Patent document 2: JP-A-2001-324604
Patent document 3: JP-A-2002-221602

### OUTLINE OF THE INVENTION

### Problems that the Invention is to Solve

The layer formed by using the above hollow silica sol, silane compound and metal chelate features excellent antireflective effect, non-glaring function and oil-proof property, but is not still enough in regard to mechanical strength as represented by scratch resistance and damp-proof property leaving room for improvements. The antireflection plate having the antireflection film is, usually, used as a front panel for optical display devices and must have a mechanical strength. Further, damp-proof property is required for the devices that are exposed to high temperatures and high humidity conditions, such as optical display devices for car navigation systems.

It is, therefore, an object of the present invention to provide an antireflection film having excellent scratch resistance and damp-proof property in addition to having a high degree of antireflective effect, and an antireflection plate obtained by laminating the film thereon.

The present inventors have conducted the study extensively in an attempt to improve the above-mentioned properties yet maintaining a high degree of antireflective effect, have discovered that the above object could be achieved by adding a specific silica sol to a system that comprises a hollow silica sol, a silane compound and a metal chelate, and have completed the present invention.

### Means for Solving the Problems

That is, according to the present invention, there is provided an antireflection film having a lowly refractive layer of a refractive index of less than 1.48 and a thickness of 50 to 200 nm, wherein the lowly refractive layer contains:

(A) a lowly refractive hollow silica sol having an average particle size of 10 to 150 nm and a refractive index of not more than 1.44;
(B) a silica sol having an average particle size of 5 to 110 nm and a refractive index of not less than 1.44 but not more than 1.50;
(C) a silane coupling compound or a hydrolyzed product thereof; and
(D) a metal chelate compound;

the lowly refractive hollow silica sol (A) and the silica sol (B) being contained at a ratio of 5 to 95% by weight:95 to 5% by weight, the silane coupling compound or the hydrolyzed product thereof (C) and the metal chelate compound (D) being contained at a ratio of 60 to 99% by weight:40 to 1% by weight, the ratio of the total amount of the lowly refractive hollow silica sol (A) and the silica sol (B) to the total amount of the silane coupling compound or the hydrolyzed product thereof (C) and the metal chelate compound (D) being 10 to 50% by weight:90 to 50% by weight, and the amount of the lowly refractive hollow silica sol (A) being not more than 30% by weight per the whole amount of the lowly refractive layer.

It is desired that the antireflection film of the present invention, further, includes the following embodiments.

1) The lowly refractive layer has a refractive index of less than 1.47, and contains the lowly refractive hollow silica sol (A) and the silica sol (B) at a ratio of 10 to 90% by weight:90 to 10% by weight and contains the silane coupling compound or the hydrolyzed product thereof (C) and the metal chelate compound (D) at a ratio of 70 to 98% by weight:30 to 2% by weight, the amount of the lowly refractive hollow silica sol (A) being not more than 20% by weight per the whole amount of the lowly refractive layer;
2) An intermediately refractive layer is laminated on the lowly refractive layer on the side of the substrate, the intermediately refractive layer having a refractive index of not less than 1.50 but less than 1.75 and a thickness of 50 to 200 nm, and containing:
(C) the silane coupling compound or the hydrolyzed product thereof;
(D) the metal chelate compound, and
(E) metal oxide particles having an average particle size of 10 to 100 nm and a refractive index of not less than 1.70 but not more than 2.80;

the silane coupling compound or the hydrolyzed product thereof being contained in an amount of 20 to 80% by weight, the metal chelate compound (D) being contained in an amount of 0.1 to 2% by weight, and the metal oxide particles (E) being contained in an amount of 20 to 80% by weight; and

3) A highly reflective layer is provided between the lowly refractive layer and the intermediately refractive layer, the highly refractive layer having a refractive index of not less than 1.60 but less than 2.00 and a thickness of 50 to 200 nm, and containing:
(C) the silane coupling compound or the hydrolyzed product thereof in an amount of 10 to 50% by weight; and
(E) the metal oxide particles of an average particle size of 10 to 100 nm and a refractive index of not less than 1.70 but not more than 2.80 in an amount of 50 to 90% by weight;

the refractive index of the highly refractive layer being larger than the refractive index of the intermediately refractive layer.

According to the present invention, further, there is provided an antireflection plate obtained by laminating any one of the above antireflection films on a transparent resin substrate with the lowly refractive layer on the visible side.

In the antireflection plate of the present invention, it is desired that:

1) A hard coating is provided between the transparent resin substrate and the antireflection film; and
2) An over-coating is provided on the surface of the lowly refractive layer of the antireflection film.

### Effects of the Invention

The antireflection film of the present invention has excellent scratch resistance and damp-proof property in addition to a high degree of antireflective effect. Therefore, the antireflection plate obtained by laminating the above film on the transparent resin substrate can be favorably used as a front panel of not only the optical display devices such as CRTs, LCDs and plasma display devices but also as a touch panel that receives mechanical pressures at all times and as a front panel of display devices for car navigation systems that are exposed to high temperatures and high humidity conditions.

### BRIEF DESCRIPTION OF THE DRAWING

FIG. 1 is a schematic view illustrating, in cross section, the structure of the antireflection plate which is a representative example of the present invention.

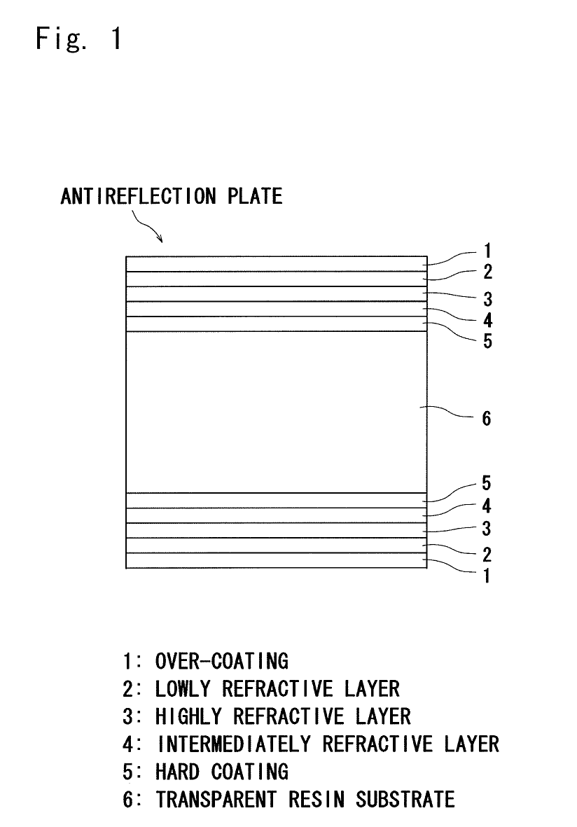

### MODE FOR CARRYING OUT THE INVENTION

### [Lowly Refractive Layer]

The antireflection film of the present invention requires the following lowly reflective layer.

The lowly refractive layer has a refractive index of less than 1.48 and a thickness of 50 to 200 nm. From the standpoint of the antireflective effect, the layer has a refractive index of, desirably, less than 1.47.

Further, the lowly refractive layer contains:

(A) a lowly refractive hollow silica sol having an average particle size of 10 to 150 nm and a refractive index of not more than 1.44 (hereinafter also referred to as lowly refractive hollow silica sol);
(B) a silica sol having an average particle size of 5 to 110 nm and a refractive index of not less than 1.44 but not more than 1.50 (hereinafter also referred to as silica sol);
(C) a silane coupling compound or a hydrolyzed product; and
(D) a metal chelate compound.

Further, the lowly refractive layer contains the lowly refractive hollow silica sol (A) and the silica sol (B) at a ratio of 5 to 95% by weight:95 to 5% by weight, and contains the silane coupling compound or the hydrolyzed product thereof (C) and the metal chelate compound (D) at a ratio of 60 to 99% by weight:40 to 1% by weight, the ratio of the total amount of the lowly refractive hollow silica sol (A) and the silica sol (B) to the total amount of the silane coupling compound or the hydrolyzed product thereof (C) and the metal chelate compound (D) being 10 to 50% by weight: 90 to 50% by weight, and the amount of the lowly refractive hollow silica sol (A) being not more than 30% by weight per the whole amount of the lowly refractive layer.

Here, as will be described later, when the antireflection film comprises a plurality of antireflection layers, the lowly refractive layer serves as the antireflection layer that becomes the outermost layer (on the visible side).

### [(A) Lowly Refractive Hollow Silica Sol]

From the standpoint of expressing the antireflective effect, it is important that the lowly refractive hollow silica sol comprises hollow silica particles having voids therein and having an average particle size of 10 to 150 nm and a refractive index of not more than 1.44 and, preferably, not more than 1.35.

The lowly refractive hollow silica sol comprises particles having voids therein, and has a density of, usually, not more than 1.5 g/cm³, which is smaller than that of other silica sols.

The lowly refractive hollow silica sol has been known per se., is produced by, for example, synthesizing silica in the presence of a surfactant that serves as a template finally followed by firing to decompose the surfactant to remove it, and has been placed in the market. In the commercially available product, however, the hollow silica sol has been dispersed in a solvent such as water or alcohol. Therefore, the solvent is inevitably mixed in the coating solution for forming the antireflection film that is prepared for forming the antireflection film of the present invention. Through the steps of drying and curing after the coating, however, the solvent volatilizes and extinguishes together with the solvent that is separately added to prepare the coating solution.

### [(B) Silica Sol]

The silica sol comprises particles that contribute to improving scratch resistance and damp-proof property, i.e., comprises individual particles or aggregated particles having an average particle size of 5 to 110 nm and a refractive index of not less than 1.44 but not more than 1.50. Unlike the lowly refractive hollow silica sol (A), the silica sol comprises non-hollow particles which are dense without voids therein, and has a density of, usually, not less than 1.9 g/cm³.

The silica sol has been known per se., and the commercially available product can be directly used in the invention. The silica sol, too, is, usually, offered in a state of being dispersed in a solvent which behaves in the same manner as that of the case of the lowly refractive hollow silica sol mentioned above.

### [(C) Silane Coupling Compound or Hydrolyzed Product Thereof]

The silane coupling compound or the hydrolyzed product thereof by itself undergoes the hydrolysis to form a dense siliceous film.

As the silane coupling compound, there can be used those that have been widely known without limitation. For example, there can be used γ-methacryloxypropyltrimethoxysilane, γ-methacryloxypropylmethyldimethoxysilane, 3-acryloxypropyltrimethoxysilane, vinyltrimethoxysilane, vinyltriethoxysilane, p-styryltrimethoxysilane, γ-glycidoxypropyltrimethoxysilane, 2-(3,4-epoxycyclohexyl) ethyltrimethoxysilane, γ-glycidoxypropylmethyldimethoxysilane, 3-glycidoxypropylmethyldiethoxysilane, γ-aminopropyltrimethoxysilane, 3-aminopropyltriethoxysilane, N-2(aminoethyl) 3-aminopropylmethyldimethoxysilane, N-2(aminoethyl) 3-aminopropyltriethoxysilane, N-2(aminoethyl) 3-aminopropyltriethoxysilane, 3-mercaptopropylmethyldimethoxysilane, 3-mercaptopropyltrimethoxysilane and 3-isocyanate propyltriethoxysilane.

Depending on their kinds, the silane coupling compounds are, preferably, the decomposed products thereof that have been hydrolyzed in advance with a dilute acid or the like in order to improve the solubility in water or solvent. There is no particular limitation on the method of hydrolysis that is conducted in advance, and there can be employed a method of partly hydrolyzing the silane coupling compound by using an acid catalyst such as acetic acid or a method of partly hydrolyzing the silane coupling agent by making the silane coupling compound and the acid present together with other components in the coating solution for forming the antireflection film.

### [(D) Metal Chelate Compound]

The metal chelate compound is contained in order to enhance the density and strength of the layer as well as to enhance the hardness of the layer. The chelate compound is a compound in which a chelating agent as represented by a bidentate ligand is coordinated in a metal such as titanium, zirconium or aluminum.

Concretely, there can be exemplified titanium chelate compounds such as triethoxy.mono(acetylacetonato) titanium, tri-n-propoxy.mono(acetylacetonato) titanium, diethoxy.bis (acetylacetonato) titanium, monoethoxy.tris(acetylacetonato) titanium, tetrakis(acetylacetonato) titanium, triethoxy.mono(ethyl acetoacetate) titanium, diethoxy.bis(ethyl acetoacetate) titanium, monoethoxy.tris(ethyl acetoacetate) titanium, monoethoxy.tris(ethyl acetoacetate) titanium, mono(acethylacetonato)tris(ethyl acetoacetate) titanium, bis(acethylacetonato)bis(ethyl acetoacetate) titanium, and tris(acethylacetonato)mono(ethyl acetoacetate) titanium;

zirconium chelate compounds such as triethoxy.mono(acetylacetonato) zirconium, tri-n-propoxy.mono(acetylacetonato) zirconium, diethoxy.bis(acetylacetonato) zirconium, monoethoxy.tris(acethylacetonato) zirconium, tetrakis(acethylacetonato) zirconium, triethoxy.mono(ethyl acetoacetate) zirconium, diethoxy.bis(ethyl acetoacetate) zirconium, monoethoxy.tris(ethyl acetoacetate) zirconium, tetrakis(ethyl acetoacetate) zirconium, mono(acetylacetonato)tris(ethyl acetoacetate) zirconium, bis(acetylacetonato)bis(ethyl acetoacetate) zirconium, and tris(acethylacetonato)mono(ethyl acetoacetate) zirconium; and

aluminum chelate compounds such as diethoxy.mono(acethylacetonato) aluminum, monoethoxy.bis(acetylacetonate) aluminum, di-i-propoxy.mono(acetylacetonato) aluminum, mono-i-propoxy.bis(ethyl acetoacetate) aluminum, monoethoxy bis(ethyl acetoacetate) aluminum, and diethoxy.mono(ethyl acetoacetate) aluminum.

### [Blending the Components (A) to (D)]

The lowly refractive layer contains the lowly refractive hollow silica sol (A) and the silica sol (B) at a ratio of 5 to 95% by weight: 95 to 5% by weight, and contains the hydrolyzed product of the silane coupling compound (C) and the metal chelate compound (D) at a ratio of 60 to 99% by weight:40 to 1% by weight.

In adding the lowly refractive hollow silica sol (A) and the silica sol (B), if the ratio of the silica sol (B) is less than 5% by weight, there is seen no improvement in the scratch resistance or in the damp-proof property.

In adding the hydrolyzed product of the silane coupling compound (C) and the metal chelate compound (D), if the ratio of the metal chelate compound (D) exceeds 40% by weight, the film becomes brittle or the chelate compound precipitates, which is not desirable.

It is, further, important that the ratio of the total amount of the lowly refractive hollow silica sol (A) and the silica sol (B) to the total amount of the silane coupling compound or the hydrolyzed product thereof (C) and the metal chelate compound (D), is 10 to 50% by weight: 90 to 50% by weight, and that the amount of the lowly refractive hollow silica sol (A) is not more than 30% by weight per the whole amount of the lowly refractive layer.

If the ratio of the total amount of the lowly refractive hollow silica sol (A) and the silica sol (B) to the total amount of the silane coupling compound or the hydrolyzed product thereof (C) and the metal chelate compound (D), is less than 10 to 90% by weight (lower limit value), the antireflective effect becomes poor. If the above ratio exceeds 50:50% by weight (upper limit value), the scratch resistance and the damp-proof property become poor. Further, if the amount of the lowly refractive hollow silica sol (A) exceeds 30% by weight per the whole amount of the lowly refractive layer, the damp-proof property becomes poor, which is not desirable.

From the standpoint of maintaining balance among the antireflective effect, scratch resistance and damp-proof property, it is desired that the ratio of addition is such that the lowly refractive hollow silica sol (A) and the silica sol (B) are added at a ratio of 10 to 90% by weight:90 to 10% by weight, the silane coupling compound or the hydrolyzed product thereof (C) and the metal chelate compound (D) are added at a ratio of 70 to 98% by weight:30 to 2% by weight, and that the amount of the lowly refractive silica sol (A) is not more than 20% by weight per the whole amount of the lowly refractive layer.

### [Transparent Resin Substrate]

There is no particular limitation on the transparent resin substrate so far as it is made of a transparent resin that excels in the shock resistance and does not hinder visibility. From the standpoint of transparency and shock resistance, it is desired to use a substrate made of an aromatic polycarbonate resin or a polymethyl methacrylate resin. The substrate may be made by laminating layers of the polycarbonate resin and the polymethyl methacrylate resin. The thickness of the substrate is suitably selected and designed from the required transparency and shock resistance, but is, usually, set to lie in a range of 0.2 to 2.0 mm.

### [Forming the Lowly Refractive Layer]

The lowly refractive layer is formed by preparing a coating solution for forming the lowly refractive layer by dissolving the above essential components (A) to (D) in specific amounts in a solvent described below and, further, dissolving therein any components for adjusting the viscosity and for facilitating the application, and applying the solution onto the transparent resin substrate followed by drying, heating and curing. From the standpoint of antireflective property, the thickness of the layer is set to lie in a range of 50 to 200 nm.

The solvents used for the coating solution for forming the lowly refractive layer are, preferably, alcohol compounds such as methyl alcohol, ethyl alcohol and propyl alcohol; aromatic compounds such as toluene and xylene; ester compounds such as ethyl acetate, butyl acetate and isobutyl acetate; and ketone compounds such as acetone, methyl ethyl ketone (MEK), methyl isobutyl ketone (MIBK) and diacetone alcohol. It is also allowable to use methylene glycol monomethyl ether acetate, ethylene glycol monomethyl ether acetate, propylene glycol monomethyl ether acetate, as well as cellosolve compounds such as methyl cellosolve, ethyl cellosolve and propylene glycol monomethyl ether.

The above components for constituting the coating solution for forming the lowly refractive layer are, usually, arbitrarily mixed and stirred at nearly room temperature to obtain a solution thereof. When a commercially available particulate sol is used, the solvent which is a dispersion medium of the sol inevitably mixes into the solution. However, the solvent in the coating solution for forming the lowly refractive layer and the solvent that is separately mixed are removed through the steps of drying and curing.

There is no particular limitation on the method of applying the solution onto the transparent resin substrate, and there can be employed a dip coating method, roll coating method, die coating method, flow coating method or spraying method. From the standpoint of quality of appearance and controlling the film thickness, however, it is desired to employ the dip coating method. Here, when the antireflection layer comprises two layers of an intermediately refractive layer that will be described later and a lowly refractive layer, the intermediately refractive layer is, first, formed on the transparent resin substrate and, thereafter, the lowly refractive layer is formed on the above layer. Further, when the antireflection layer comprises three layers of an intermediately refractive layer and a highly refractive layer both of which will be described later, and a lowly refractive layer, the intermediately refractive layer is, first, formed on the transparent resin substrate and, next, the highly refractive layer is formed on the above layer and, thereafter, the lowly refractive layer is formed thereon.

### [Intermediately Refractive Layer]

In order to further enhance the antireflective effect, it is desired that the antireflection film of the present invention has an intermediately refractive layer laminated on the substrate side of the lowly refractive layer.

The intermediately refractive layer has a refractive index of not less than 1.50 but less than 1.75 and a thickness of 50 to 200 nm, and contains:

(C) the silane coupling compound or the hydrolyzed product thereof;
(D) the metal chelate compound; and
(E) the metal oxide particles having an average particle size of 10 to 100 nm and a refractive index of not less than 1.70 but not more than 2.80 (hereinafter also referred to as metal oxide particles);

the silane coupling compound or the hydrolyzed product thereof (C) being contained in an amount of 20 to 80% by weight, the metal chelate compound (D) being contained in an amount of 0.1 to 2% by weight, and the metal oxide particles (E) being contained in an amount of 20 to 80% by weight.

### [(E) Metal Oxide Particles]

The metal oxide particles have an average particle size of 10 to 100 nm and a refractive index of not less than 1.70 but not more than 2.80, and are contained so that the intermediately refractive layer exhibits a refractive index of not less than 1.50 but less than 1.75.

As the metal oxide particles, there can be used zirconium oxide particles (refractive index=2.40), composite zirconium metal oxide particles obtained by compounding the zirconium oxide and other oxide such as silicon oxide together on a molecular level to adjust the refractive index, titanium oxide particles (refractive index=2.71), and composite titanium metal oxide particles obtained by compounding the titanium oxide and other oxide such as zirconium oxide together on a molecular level to adjust the refractive index. These metal oxide particles are suitably combined together to prepare a layer of a desired refractive index. These particles have been known per se. and have been placed in the market.

### [Forming the Intermediately Refractive Layer]

The intermediately refractive layer is formed by preparing a coating solution for forming the intermediately refractive layer by dissolving the above essential components (C), (D) and (E) in specific amounts in the solvents used for forming the lowly refractive layer and, further, dissolving any components therein, and applying the solution onto the transparent resin substrate followed by drying, heating and curing. From the standpoint of antireflective property, the thickness of the layer is set to lie in a range of 50 to 200 nm.

There is no specific limitation on the order of mixing the above components that constitute the coating solution for forming the intermediately refractive layer, on the mixing conditions or on the method of applying the coating solution onto the transparent resin substrate, and there can be employed the method that was used for forming the lowly refractive layer.

When the antireflection film of the invention comprises the two layers of the lowly refractive layer and the intermediately refractive layer, however, the antireflective effect is little exhibited unless the intermediately refractive layer is present on the side of the transparent resin substrate. Therefore, the intermediately refractive layer is formed, first, on the transparent resin substrate and, thereafter, the lowly refractive layer is formed on the intermediately refractive layer according to the above-mentioned method to form the two layers.

### [Highly Refractive Layer]

In order to attain a very high antireflective effect, it is desired that the antireflection film of the present invention, further, has a highly refractive layer laminated between the lowly refractive layer and the intermediately refractive layer.

The highly refractive layer has a refractive index of not less than 1.60 but less than 2.00 and a thickness of 50 to 200 nm, and contains:

(C) the silane coupling compound or the hydrolyzed product thereof in an amount of 10 to 50% by weight; and
(D) the metal oxide particles in an amount of 50 to 90% by weight;
and is so designed that the refractive index of the highly refractive layer is larger than the refractive index of the intermediately refractive layer.

The silane coupling compound or the hydrolyzed product thereof (C) and the metal oxide particles (E) are as described above.

### [Forming the Highly Refractive Layer]

The highly refractive layer is formed by preparing a coating solution for forming the highly refractive layer by dissolving the above essential components (C) and (E) in specific amounts in the solvents used for forming the lowly refractive layer and, further, dissolving any components therein, and applying the solution onto the transparent resin substrate followed by drying, heating and curing. From the standpoint of antireflective property, the thickness of the above layer is set to lie in a range of 50 to 200 nm.

There is no specific limitation on the order of mixing the above components that constitute the coating solution for forming the highly refractive layer, on the mixing conditions or on the method of applying the coating solution onto the transparent resin substrate, and there can be employed the method that was used for forming the lowly refractive layer.

When the antireflection film of the invention comprises the three layers of the lowly refractive layer, the intermediately refractive layer and the highly refractive layer, however, it is necessary that the highly refractive layer is present between the lowly refractive layer and the intermediately refractive layer. Therefore, the intermediately refractive layer is formed, first, on the transparent resin substrate according to the above-mentioned method and, next, the highly refractive layer is formed on the intermediately refractive layer and, thereafter, the lowly refractive layer is formed thereon to form the three layers.

The antireflection film and the antireflection plate of the invention are not limited to the ones having the above-mentioned layer constitutions only. For instance, it is desired to provide a hard coating as the undercoating between the transparent resin substrate and the intermediately refractive layer. As the hard coating, there can be used a coating of the thermosetting type or the coating of the ultraviolet ray-curing type or the electron ray-curing type. As the coating of the thermosetting type, there can be exemplified those of the silicone type, isocyanate type and epoxy type. As the coating of the ultraviolet ray-curing type or the electron ray-curing type, there can be exemplified those of the urethane acrylate type, epoxy acrylate type and copolymerized acrylate type.

Further, an over-coating may be provided to protect the lowly refractive layer. As the over-coating, there can be exemplified the coating of an organopolysiloxane material or a fluorine-contained resin to impart wear resistance and scratch resistance. As the polysiloxane coating, there can be exemplified those of the methylpolysiloxane or the dimethylpolysiloxane having silanol group, alkoxy group, acetyl group, phenyl group, polyether group or perfluoroalkyl group on the side chain. As the fluorine-contained resin, further, there is used an amorphous perfluorofluorine-contained resin and, specifically, an amorphous perfluorofluorine-contained resin having a ring structure on the main chain thereof.

Moreover, a tackifier layer comprising a tackifier of an acrylic type, rubber type or silicone type can be provided on the back side of the transparent resin substrate. Further, the antireflection film of the invention may be laminated on both the front and back surfaces of the transparent resin substrate.

### EXAMPLES

The invention will now be concretely described by way of Examples to which only, however, the invention is in no way limited. Further, it does not mean that the combinations of the features described in Examples are all necessary for the means for solving the problems of the invention.

Described below are the components, abbreviations thereof and the testing methods used in Examples and Comparative Examples.

### (A) Lowly Refractive Hollow Silica Sols:

A-1: average particle size, 60 nm; refractive index, 1.25; dispersed in the IPA; solid portion, 20 wt %
A-2: average particle size, 60 nm; refractive index, 1.25; dispersed in the MIBK; solid portion, 20 wt %
A-3: average particle size, 50 nm; refractive index, 1.30; dispersed in the IPA; solid portion, 20 wt %

### (B) Silica Sols:

B-1: average particle size, 10 nm; refractive index, 1.46; dispersed in the IPA; solid portion, 20 wt %
B-2: average particle size, 12 nm; refractive index, 1.46; dispersed in the IPA; solid portion, 20 wt %
B-3: average particle size, 80 nm; refractive index, 1.46; dispersed in the IPA; solid portion, 20 wt %

### (C) Hydrolyzed Products of the Silane Coupling Compound:

C-1: γ-glycidoxypropyltrimethoxysilane (blended with acetic acid)
C-2: 3-acryloxypropyltrimethoxysilane (blended with acetic acid)
C-3: 2-(3,4-epoxycyclohexyl)ethyltrimethoxysilane (blended with acetic acid)

### (D) Metal Chelate Compounds:

D-1: zirconium dibutoxybis(ethyl acetoacetate)
D-2: aluminum alkylacetoacetate diisopropylate
D-3: aluminum trisacetylacetonato

### (E) Metal Oxide Particles:

E-1: average particle size, 50 nm; zirconia sol; refractive index, 2.40; dispersed in the PGM; solid portion, 55 wt %
E-2: average particle size, 20 nm; titania sol; refractive index, 2.71; dispersed in the MIBK; solid portion, 20 wt %

### (F) Others:

F-1: IPA, isopropyl alcohol
F-2: MIBK, methylbutylketone
F-3: PGM, propylene glycol monomethyl ether
F-4: photopolymerization initiator
F-5: polyfunctional urethane acrylate
F-6: reactive ultraviolet ray absorber
F-7: 0.05N acetic acid

### [Testing the Antireflection]

The initial test piece and the test piece after left to stand in a constant-temperature constant-humidity testing device (set at 65° C., 95%) for 96 hours were measured for their reflection factors on both surfaces thereof by attaching an integrating sphere to a spectrophotometer (Model, V-650, manufactured by JASCO Co.).

### [Testing the Damp-Proof Property]

A rate of change relative to the initial reflection factor was calculated from a difference between the initial reflection factor and the reflection after the constant-temperature constant-humidity testing, and was regarded to be an indication of damp-proof property. The smaller this value, the more excellent the damp-proof property is.

### [Testing the Scratch Resistance]

The test piece was set to a scratch testing device and was moved round trip 150 times over a distance of 50 mm on a steel wool #0000 under a load of 500 g/cm² to measure the degree of being scratched. Concretely, the scratch resistance was evaluated based on the number of scratches that could be seen as the reflected light appearing as highly reflective white lines as the antireflection film was removed and the hard coating or the substrate was exposed.

### Example 1

A lowly refractive layer was formed on a polymethyl methacrylate (PMMA) resin substrate of a thickness of 1 mm by the following method.

### [Composition of the Coating Solution for Forming the Lowly Refractive Layer]

A-1: 18.00 g (solid component ratio, 15.00)

B-1: 2.00 g (solid component ratio, 1.67)

C-1: 12.00 g (solid component ratio, 50.00)

D-1: 8.00 g (solid component ratio, 33.33)

F-7: 11.58 g

F-1: 948.42 g

### [Composition of the Solution for Forming the Hard Coating]

C-1: 25.00 g (solid component ratio, 10.00)

F-5: 132.50 g (solid component ratio, 53.00)

B-1: 75.00 g (solid component ratio, 30.00)

D-1: 2.00 g

F-1: 371.50 g

F-2: 371.50 g

F-4: 10.0 g (solid component ratio, 4.00)

F-6: 7.50 g (solid component ratio, 3.00)

F-7: 5.0 g

First, the PMMA resin substrate was dip-coated with the coating solution of the above composition for forming the hard coating, and was dried at 60° C. for 5 minutes and was cured with UV to form a hard coating of a thickness of about 2 μm. Next, the substrate having the hard coating was dipped in the coating solution having the above-mentioned composition for forming the lowly refractive layer, and was heat-treated at 100° C. for 120 minutes to form a lowly refractive layer of a thickness of 100 nm.

The obtained antireflection plate having the antireflection film was measured for its reflection factor and damp-proof property in compliance with the above-mentioned testing methods, and was evaluated to obtain the results as shown in Table 1.

### Examples 2 to 4

Antireflection plates having antireflection films were prepared in the same manner as in Example 1 but using the coating solutions for forming the lowly refractive layers shown in Table 1, and were measured in the same manner to obtain the results as shown in Table 1.

TABLE 1

| | | Example 1 | | | Example 2 | | |
|---|---|---|---|---|---|---|---|
| | | *3 | *4 | *5 | *3 | *4 | *5 |
| *1 | | | | | | | |
| Ratio | A:B | | 90:10 | 90:10 | | 10:90 | 10:90 |
| A-1 | | 18.00 | 3.60 | 15.00 | | | |
| A-2 | | | | | 2.50 | 0.50 | 2.00 |
| A-3 | | | | | | | |
| B-1 | | 2.00 | 0.40 | 1.67 | 22.50 | 4.50 | 18.00 |
| B-2 | | | | | | | |
| B-3 | | | | | | | |
| Ratio | C:D | | 60:40 | 60:40 | | 60:40 | 60:40 |
| C-1 | | 12.00 | 12.00 | 50.00 | | | |
| C-2 | | | | | 12.00 | 12.00 | 48.00 |
| C-3 | | | | | | | |
| D-1 | | 8.00 | 8.00 | 33.33 | 8.00 | 8.00 | 32.00 |
| D-2 | | | | | | | |
| D-3 | | | | | | | |
| Ratio | A + | | 4:20 | 17:83 | | 5:20 | 20:80 |
| | B:C + | | | | | | |
| | D | | | | | | |
| F-1 | | 948.42 | | | 944.25 | | |
| F-7 | | 11.58 | | | 10.70 | | |
| Total | | 1000.00 | 24.00 | 100.00 | 999.95 | 25.00 | 100.00 |
| Properties | | | | | | | |
| *2 | | | | | | | |
| Initial | | | | 4.2% | | | 7.4% |
| 65° C., 95%, 96 hrs. | | | | 4.7% | | | 7.5% |
| Rate of change | | | | 112% | | | 101% |
| Scratch test | | no white scratch | | | no white scratch | | |
| | | Example 3 | | | Example 4 | | |
| | | *3 | *4 | *5 | *3 | *4 | *5 |
| *1 | | | | | | | |
| Ratio | A:B | | 10:90 | 10:90 | | 50:50 | 50:50 |
| A-1 | | | | | 20.00 | 4.00 | 14.29 |
| A-2 | | | | | | | |
| A-3 | | 4.00 | 0.80 | 3.33 | | | |
| B-1 | | | | | | | |
| B-2 | | | | | 20.00 | 4.00 | 14.29 |
| B-3 | | 36.00 | 7.20 | 30.00 | | | |
| Ratio | C:D | | 90:10 | 90:10 | | 90:10 | 90:10 |
| C-1 | | | | | 18.00 | 18.00 | 64.29 |
| C-2 | | | | | | | |
| C-3 | | 12.00 | 12.00 | 50.00 | | | |
| D-1 | | | | | | | |
| D-2 | | 1.33 | 4.00 | 16.67 | | | |
| D-3 | | | | | 2.00 | 2.00 | 7.14 |
| Ratio | A + | | 8:16 | 33:67 | | 8:20 | 29:71 |
| | B:C + | | | | | | |
| | D | | | | | | |
| F-1 | | 936.48 | | | 929.30 | | |
| F-7 | | 10.07 | | | 10.70 | | |
| Total | | 999.88 | 24.00 | 100.00 | 1000.00 | 28.00 | 100.00 |

| | | |
|---|---|---|
| Properties | | |
| *2 | | |
| Initial | 7.0% | 4.0% |
| 65° C., 95%, 96 hrs. | 7.4% | 4.5% |
| Rate of change | 106% | 113% |

| | | |
|---|---|---|
| Scratch test | no white scratch | no white scratch |

*1: Lowly refractive layer, 100 nm thick;
*2: Rate of reflection factor change;
*3: Amount g;
*4: Amount of solid component;
*5: Solid component ratio

### Comparative Examples 1 to 4

Antireflection plates having antireflection films were prepared in the same manner as in Example 1 but using the coating solutions for forming the lowly refractive layers shown in Table 2, and were measured in the same manner to obtain the results as shown in Table 2.

TABLE 2

| | | Comparative Example 1 | | | Comparative Example 2 | | |
|---|---|---|---|---|---|---|---|
| | | *3 | *4 | *5 | *3 | *4 | *5 |
| *1 | | | | | | | |
| Ratio | A:B | | 80:20 | 80:20 | | 0:100 | 0:100 |
| A-1 | | | | | | | |
| A-2 | | | | | | | |
| A-3 | | 50.00 | 10.00 | 30.77 | | | |
| B-1 | | | | | | | |
| B-2 | | 12.50 | 2.50 | 7.69 | 25.00 | 5.00 | 20.00 |
| B-3 | | | | | | | |
| Ratio | C:D | | 60:40 | 60:40 | | 60:40 | 60:40 |
| C-1 | | 12.00 | 12.00 | 36.92 | | | |
| C-2 | | | | | 12.00 | 12.00 | 48.00 |
| C-3 | | | | | | | |
| D-1 | | 8.00 | 8.00 | 24.62 | 8.00 | 8.00 | 32.00 |
| D-2 | | | | | | | |
| D-3 | | | | | | | |
| Ratio | A + B:C + D | | 12.5:20 | 38:62 | | 5:20 | 20:80 |
| F-1 | | 915.50 | | | 944.20 | | |
| F-7 | | 9.50 | | | 10.80 | | |
| Total | | 1007.50 | 32.50 | 100.00 | 1000.00 | 25.00 | 100.00 |

| | | |
|---|---|---|
| Properties | | |
| *2 | | |
| Initial | 2.5% | 7.7% |
| 65° C., 95%, 96 hrs. | 3.9% | 7.8% |
| Rate of change | 156% | 101% |

| | | |
|---|---|---|
| Scratch test | tens of white scratches | no white scratch |

| | | Comparative Example 3 | | | Comparative Example 4 | | |
|---|---|---|---|---|---|---|---|
| | | *3 | *4 | *5 | *3 | *4 | *5 |
| *1 | | | | | | | |
| Ratio | A:B | | 10:90 | 10:90 | | 100:0 | 100:0 |
| A-1 | | | | | | | |
| A-2 | | 8.00 | 1.60 | 5.71 | 35.00 | 7.00 | 25.93 |
| A-3 | | | | | | | |
| B-1 | | | | | | | |
| B-2 | | | | | | | |
| B-3 | | 72.00 | 14.40 | 51.43 | | | |
| Ratio | C:D | | 90:10 | 90:10 | | 60:40 | 60:40 |
| C-1 | | | | | 12.00 | 12.00 | 44.44 |
| C-2 | | | | | | | |
| C-3 | | 10.80 | 10.80 | 38.57 | | | |
| D-1 | | | | | 8.00 | 8.00 | 29.63 |
| D-2 | | 1.20 | 1.20 | 4.29 | | | |
| D-3 | | | | | | | |
| Ratio | A + B:C + D | | 16:12 | 57:43 | | 7:20 | 23:77 |
| F-1 | | 907.20 | | | 934.20 | | |
| F-7 | | 10.80 | | | 10.80 | | |
| Total | | 1010.00 | 28.00 | 100.00 | 1000.00 | 27.00 | 100.00 |

| | | |
|---|---|---|
| Properties | | |
| *2 | | |
| Initial | 6.0% | 3.1% |
| 65° C., 95%, 96 hrs. | 6.8% | 4.6% |
| Rate of change | 113% | 148% |

| | | |
|---|---|---|
| Scratch test | tens of white scratches | several white scratches |

*1: Lowly refractive layer, 100 nm thick;
*2: Rate of reflection factor change;
*3: Amount g;
*4: Amount of solid component
*5: Solid component ratio

### Examples 5 and 6

By using the coating solutions for forming the lowly refractive layers, coating solutions for forming the intermediately refractive layers and coating solutions for forming the highly refractive layers, the coating solutions having compositions shown in Table 3 below, there were prepared antireflection plates having an antireflection film that comprised of three layers. The results of evaluation were as shown in Table 3.

Like in Example 1, a hard coating was formed on a 1 mm-thick PMMA resin substrate. The substrate having the hard coating was dipped in the coating solution for forming the intermediately refractive layer, and was heat-treated at 90° C. for 30 minutes to form the intermediately refractive layer of a thickness of 85 nm. Next, the substrate was dipped in the coating solution for forming the highly refractive layer, and was heat-treated at 90° C. for 30 minutes to form the highly refractive layer of a thickness of 80 nm. Thereafter, the substrate was dipped in the coating solution for coating the lowly refractive layer, and was heat-treated at 100° C. for 120 minutes to form the lowly refractive layer of a thickness of 100 nm.

### Example 7

An antireflection plate having an antireflection film comprised of two layers was prepared and evaluated in compliance with Example 5 but using a coating solution for forming the lowly refractive layer and a coating solution for forming the intermediately refractive layer shown in Table 3. The results were as shown in Table 3.

TABLE 3

| | | Example 5 | | | Example 6 | | | Example 7 | | |
|---|---|---|---|---|---|---|---|---|---|---|
| | | *4 | *5 | *6 | *4 | *5 | *6 | *4 | *5 | *6 |
| *1 | | | | | | | | | | |
| Ratio | A:B | | 90:10 | 90:10 | | 90:10 | 90:10 | | 90:10 | 90:10 |
| A-1 | | 18.00 | 3.60 | 15.00 | 18.00 | 3.60 | 15.00 | 18.00 | 3.60 | 15.00 |
| B-1 | | 2.00 | 0.40 | 1.67 | 2.00 | 0.40 | 1.67 | 2.00 | 0.40 | 1.67 |
| Ratio | C:D | | 60:40 | 60:40 | | 60:40 | 60:40 | | 60:40 | 60:40 |
| C-1 | | 12.00 | 12.00 | 50.00 | 12.00 | 12.00 | 50.00 | 12.00 | 12.00 | 50.00 |
| D-1 | | 8.00 | 8.00 | 33.33 | 8.00 | 8.00 | 33.33 | 8.00 | 8.00 | 33.33 |
| Ratio | A + B:C + D | | 4:20 | 17:83 | | 4:20 | 17:83 | | 4:20 | 17:83 |
| *3 | | | | | | | | | | |
| F-1 | | 948.42 | | | 948.42 | | | 948.42 | | |
| F-7 | | 11.58 | | | 11.58 | | | 11.58 | | |
| Total | | 1000.00 | 24.00 | 100.00 | 1000.00 | 24.00 | 100.00 | 1000.00 | 24.00 | 100.00 |
| *2 | | | | | | | | | | |
| E-1 | | 40.8 | 22.44 | 64.04 | | | | | | |
| E-2 | | | | | 38.00 | 7.60 | 33.55 | | | |
| C-1 | | 10.20 | 10.20 | 29.11 | 14.00 | 14.00 | 61.81 | | | |
| D-1 | | 2.40 | 2.40 | 6.85 | 1.05 | 1.05 | 4.64 | | | |
| F-1 | | 470.47 | | | 471.00 | | | | | |
| F-2 | | 470.48 | | | 471.01 | | | | | |
| F-7 | | 5.65 | | | 4.94 | | | | | |
| Total | | 1000.00 | 35.04 | 100.00 | 1000.00 | 22.65 | 100.00 | | | |

*1: Lowly refractive layer, 100 nm thick;
*2: Highly refractive layer, 80 nm thick;
*3: Total of solid components;
*4: Amount g;
*5: Amount of solid component;
*7: Solid component ratio

| | Example 5 | | | Example 6 | | | Example 7 | | |
|---|---|---|---|---|---|---|---|---|---|
| | *3 | *4 | *5 | *3 | *4 | *5 | *3 | *4 | *5 |
| *1 | | | | | | | | | |
| E-1 | 25.6 | 14.08 | 26.58 | | | | 23.00 | 12.65 | 25.22 |
| E-2 | | | | 23.00 | 4.60 | 10.93 | | | |
| C-1 | 38.40 | 38.40 | 72.48 | 37.00 | 37.00 | 87.89 | 37.00 | 37.00 | 73.78 |
| D-1 | 0.50 | 0.50 | 0.94 | 0.50 | 0.50 | 1.19 | 0.50 | 0.50 | 1.00 |
| F-1 | 466.30 | | | 466.28 | | | 466.28 | | |
| F-2 | 466.30 | | | 466.28 | | | 466.28 | | |
| F-7 | 2.9 | | | 6.90 | | | 6.90 | | |
| Total | 1000.00 | 52.98 | 100.00 | 1000.00 | 42.10 | 100.00 | 1000.00 | 50.20 | 100.00 |
| Properties | | | | | | | | | |
| *2 | | | | | | | | | |
| Initial | | | 1.5% | | | 1.3% | | | 2.0% |
| 65° C., 95%, | | | 1.7% | | | 1.5% | | | 2.3% |
| 96 hrs. | | | | | | | | | |
| Rate of | | | 113% | | | 115% | | | 115% |
| change | | | | | | | | | |

| | | | |
|---|---|---|---|
| Scratch test | no white scratch | no white scratch | no white scratch |

*1: Intermediately refractive layer, 85 nm thick;
*2: Rate of reflection factor change;
*3: Amount g;
*4: Amount of solid component;
*5: Solid component ratio

Comparison of Example 1 with Comparative Example 1 tells that the damp-proof property becomes poor if the lowly refractive layer contains the lowly refractive hollow silica sol (A) in an amount in excess of 30% by weight. From Comparative Example 2, it is learned that the antireflection capability becomes insufficient if the lowly refractive layer contains no lowly refractive hollow silica sol (A). Further, from Comparative Example 3, it is learned that the scratch resistance becomes poor if the ratio of the total amount of the lowly refractive hollow silica sol (A) and the silica sol (B) to the total amount of the silane coupling compound or the hydrolyzed product thereof (C) and the metal chelate compound (D) exceeds 50:50% by weight (upper limit value). Comparative Example 4 teaches that not only the damp-proof property but also the scratch resistance become poor if there is contained no silica sol (B).

1. An antireflection film having a lowly refractive layer of a refractive index of less than 1.48 and a thickness of 50 to 200 nm, wherein said lowly refractive layer contains:
(A) a lowly refractive hollow silica sol having an average particle size of 10 to 150 nm and a refractive index of not more than 1.44;
(B) a silica sol having an average particle size of 5 to 110 nm and a refractive index of not less than 1.44 but not more than 1.50;
(C) a silane coupling compound or a hydrolyzed product thereof; and
(D) a metal chelate compound;
the lowly refractive hollow silica sol (A) and the silica sol (B) being contained at a ratio of 5 to 95% by weight:95 to 5% by weight, the silane coupling compound or the hydrolyzed product thereof (C) and the metal chelate compound (D) being contained at a ratio of 60 to 99% by weight:40 to 1% by weight, the ratio of the total amount of the lowly refractive hollow silica sol (A) and the silica sol (B) to the total amount of the silane coupling compound or the hydrolyzed product thereof (C) and the metal chelate compound (D) being 10 to 50% by weight:90 to 50% by weight, and the amount of the lowly refractive hollow silica sol (A) being not more than 30% by weight per the whole amount of the lowly refractive layer.

2. The antireflection film according to claim 1, wherein the lowly refractive layer has a refractive index of less than 1.47, and contains the lowly refractive hollow silica sol (A) and the silica sol (B) at a ratio of 10 to 90% by weight:90 to 10% by weight and contains the silane coupling compound or the hydrolyzed product thereof (C) and the metal chelate compound (D) at a ratio of 70 to 98% by weight:30 to 2% by weight, the amount of the lowly refractive hollow silica sol (A) being not more than 20% by weight per the whole amount of the lowly refractive layer.

3. The antireflection film according to claim 1, wherein an intermediately refractive layer is laminated on the lowly refractive layer on the side of the substrate, said intermediately refractive layer having a refractive index of not less than 1.50 but less than 1.75 and a thickness of 50 to 200 nm, and containing:
(C) the silane coupling compound or the hydrolyzed product thereof;
(D) the metal chelate compound, and
(E) metal oxide particles having an average particle size of 10 to 100 nm and a refractive index of not less than 1.70 but not more than 2.80;
the silane coupling compound or the hydrolyzed product thereof being contained in an amount of 20 to 80% by weight, the metal chelate compound (D) being contained in an amount of 0.1 to 2% by weight, and the metal oxide particles (E) being contained in an amount of 20 to 80% by weight.

4. The antireflection film according to claim 3, wherein a highly reflective layer is provided between the lowly refractive layer and the intermediately refractive layer, said highly refractive layer having a refractive index of not less than 1.60 but less than 2.00 and a thickness of 50 to 200 nm, and containing:
(C) the silane coupling compound or the hydrolyzed product thereof in an amount of 10 to 50% by weight; and
(E) the metal oxide particles of an average particle size of 10 to 100 nm and a refractive index of not less than 1.70 but not more than 2.80 in an amount of 50 to 90% by weight;
the refractive index of the highly refractive layer being larger than the refractive index of the intermediately refractive layer.

5. An antireflection plate obtained by laminating the antireflection film of claim 1 on a transparent resin substrate with the lowly refractive layer on the visible side.

6. The antireflection plate according to claim 5, wherein a hard coating is provided between the transparent resin substrate and the antireflection film.

7. The antireflection plate according to claim 6, wherein an over-coating is provided on the surface of the lowly refractive layer of the antireflection film.

8. The antireflection film according to claim 1, wherein the lowly refractive hollow silica sol (A) and the silica sol (B) are contained at a ratio of 50 to 90% by weight:50 to 10% by weight.
